(19) United States
(12) Patent Application Publication
(10) Pub. No.: US 2022/0402824 A1
(43) Pub. Date: Dec. 22, 2022

(54) METHOD OF PREPARING BSCCO-BASED MATERIALS

(71) Applicant: National University of Singapore, Singapore (SG)

(72) Inventors: Marcos Vinicius SURMANI MARTINS, Singapore (SG); Antonio Helio CASTRO NETO, Singapore (SG); Juan Alfredo GUEVARA CARRIO, Singapore (SG); Massimo SPINA, Singapore (SG)

(21) Appl. No.: 17/779,679

(22) PCT Filed: Nov. 27, 2020
(86) PCT No.: PCT/SG2020/050700

§ 371 Date: May 25, 2022

(30) Foreign Application Priority Data
Nov. 29, 2019 (SG) 10201911407X

(51) Int. Cl. C04B 35/45; C04B 35/624; C04B 35/626; C04B 35/64

(52) U.S. Cl. CPC C04B 35/4521; C04B 35/624; C04B 35/62645; C04B 35/64; C04B 2235/3208; C04B 2235/3213; C04B 2235/5436; C04B 2235/449; C04B 2235/761; C04B 2235/78; C04B 2235/80

(57) ABSTRACT

The present invention provides a method of preparing bulk BSCCO-based material, the method comprising: mixing a first solution with a second solution at a pre-determined temperature to form a gel, wherein the first solution comprises salts of at least bismuth, strontium, calcium and copper and the second solution comprises a precipitating agent; drying the gel to form a xerogel; grinding the xerogel to form a homogeneous metalorganic precursor; and calcining the homogeneous metalorganic precursor to form bulk BSCCO-based materials. Further steps may enable preparation of 2D BSCCO flakes.

### TECHNICAL FIELD

The present invention relates to a method of preparing bismuth strontium calcium copper oxide (BSCCO)-based materials.

### BACKGROUND

Stable layers of various two-dimensional (2D) materials have been isolated following the advent of graphene. These layers, such as BSCCO system, only one or several unit cells thick, have enabled the fabrication of devices with good functionality. Due to its physical properties, the phase Bi₂Sr₂CaCu₂Oₓ (BSCCO-2212) of a BSCCO system is a suitable material for high magnetic field applications. As a bulk material, BSCCO-2212 has enabled the fabrication of round wires exhibiting high critical current densities without anisotropy in magnetic fields. These wires are used in various applications such as in the construction of subatomic particle accelerator magnets, rails for high speed trains, and biomedical MRI machines, just to name a few.

The high anisotropy of the crystalline structure of BSCCO-2212 allows mechanical exfoliation of single bulk crystals down to half-unit-cell thickness. The method of successive cleavage of a single crystal has been applied to BSCCO-2212, allowing the fabrication of the 2D exfoliated superconductors, as well as a superconductive graphene/BSCCO-2212 van der Waals heterostructure. However, these methods are formed from methods which are difficult to be scaled up to an industrial level or require mechanical cleavage of bulk single crystals which should not have any other phase.

There is, therefore, a need for an improved method of preparing BSCCO-based materials which may be scaled up.

### SUMMARY OF THE INVENTION

The present invention seeks to address these problems, and/or to provide an improved and scalable method of preparing BSCCO-based materials.

According to a first aspect, the present invention provides a method of preparing bulk BSCCO-based materials, the method comprising:
mixing a first solution with a second solution at a pre-determined temperature to form a gel, wherein the first solution comprises salts of at least bismuth, strontium, calcium and copper and the second solution comprises a precipitating agent;
drying the gel to form a xerogel;
grinding the xerogel to form a homogeneous metalorganic precursor; and
calcining the homogeneous metalorganic precursor to form bulk BSCCO-based material.

The first solution may comprise any suitable salt of at least bismuth, strontium, calcium and copper. For example, the first solution may comprise an O-containing salt of at least bismuth, strontium, calcium and copper. According to a particular aspect, the first solution may comprise acetates, methanoates, propanoates, or a combination thereof.

According to another particular aspect, the first solution may be an aqueous solution comprising the salts of at least bismuth, strontium, calcium and copper.

The precipitating agent may be any suitable precipitating agent. For example, the precipitating agent may be, but not limited to: oxalic acid, malonic acid, maleic acid, or a combination thereof.

The second solution may comprise the precipitating agent in an organic solvent. The organic solvent may be any suitable organic solvent. For example, the organic solvent may be, but not limited to: isopropanol, n-propanol, n-butanol, t-butanol, or a combination thereof.

The pre-determined temperature may be any suitable temperature. For example, the pre-determined temperature may be −2-5° C.

The drying may be under suitable conditions. In particular, the drying may comprise drying the gel at a suitable temperature and for a suitable period of time. For example, the drying may be at a temperature of 35-150° C.

The calcining may be at suitable conditions. In particular, the calcining may comprise calcining the homogeneous metalorganic precursor at a suitable temperature and for a suitable period of time. For example, the calcining may be at a temperature of 600-1000° C. The calcining may be carried out for 5-10 hours/g of the homogeneous metalorganic precursor.

The method may further comprise pelletizing the bulk BSCCO-based material to form pelletized bulk BSCCO-based material. The pelletizing may be under suitable conditions.

The method may further comprise heating the pelletized bulk BSCCO-based material. The heating may be under suitable conditions. In particular, the heating may comprise heating at a suitable temperature and for a suitable period of time. For example, the heating may be at a temperature of 700-950° C. The heating may be carried out for 12-24 hours.

The bulk BSCCO-based material may be any suitable form of BSCCO. According to a particular aspect, the bulk BSCCO-based material may comprise BSCCO-2212. In particular, the bulk BSCCO-based material may comprise Bi_{1.8}Sr_{1.8}Ca_{1.2}Cu_{2.2}O_{8.22}. Even more in particular, the bulk BSCCO-based material may comprise: BSCCO-2212 platelets, BSCCO-2212 whisker or a combination thereof.

According to a particular aspect, the method may further comprise growing BSCCO crystals from the bulk BSCCO-based material. The method may further comprise exfoliating the BSCCO crystals to form 2D BSCCO flakes. The exfoliating may be by any suitable exfoliation methods. For example, the exfoliating may comprise mechanical exfoliation, liquid phase exfoliation, or a combination thereof.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings. In the drawings:

FIG. 1 shows a Differential Scanning Calorimetry (DSC) curve after calcination and milling of the xerogel obtained from the method according to one embodiment of the present invention;

FIG. 2 shows Scanning Electron Microscopy (SEM) images of sintered BSCCO samples; FIG. 2(a) shows an overview of two different lamellae regions; FIG. 2(b) shows a region with well-defined lamellar particles; FIG. 2(c) shows lamellar particles and needle shaped particles; FIGS. 2(d), (e) and (f) shows magnification of morphological details of lamellar particles;

FIG. 3(a) shows a linear analysed lamellar region; FIG. 3(b) shows a distribution histogram of elements across the line in FIG. 3(a);

FIG. 4 shows a characteristic X-ray dispersion spectrum of the present elements in the sintered material;

FIG. 5 shows an X-ray diffraction spectrum of the sintered material;

FIG. 6 shows Transmission Electron Microscopy (TEM) images of lamellae; FIG. 6(a) shows dislocations in three different regions and segregations or clusters; FIG. 6(b) shows a region with isocline contours;

FIG. 7 shows high resolution TEM images; FIG. 7(a) shows a possible sub contour with higher magnification of the region showed on the left; FIG. 7(b) shows domain borders;

FIG. 8 shows a graph of thermal treatment for crystal growth;

FIG. 9 shows an optical microscopy image of BSCCO-2212 whiskers grown in a platinum crucible;

FIG. 10 shows an SEM image of BSCCO-2212 whiskers grown in a platinum crucible;

FIG. 11 shows the chemical composition of whiskers;

FIG. 12(a) shows a TEM image of a typical whisker; FIG. 12(b) shows a region of stacking faults; FIG. 12(c) shows two different regions with disorder;

FIG. 13 shows exfoliated thin flakes of BSCCO-2212 obtained by micromechanical cleavage;

FIGS. 14(a) to (f) show SEM images of few layers of BSCCO-2212 flakes;

FIG. 15 shows an analysed BSCCO-2212 flake with marked regions for Raman spectra collection;

FIG. 16 shows Raman spectrum of BSCCO-2212 flake with modes in the region 100 cm⁻¹ to 700 cm⁻¹;

FIG. 17 shows examples of nano-devices fabricated from few layers BSCCO-2212 on 300 nm-thick SiO₂ and contacted with Ag contacts;

FIG. 18 shows I/V characteristics of a nano-device at T=300K and ambient atmosphere;

FIG. 19 shows an AFM image of a typical thin flake of BSCCO-2212 from mechanical exfoliation of whiskers;

FIG. 20 shows an AFM image of nano-platelet of BSCCO-2212 from mechanical exfoliation of whiskers;

FIG. 21 shows resistivity characteristics of the cleaved BSCCO-2212 micro platelet as a function of temperature; and

FIG. 22 shows magnetoresistance of the mechanically-cleaved micro platelet at 4.2K under a magnetic field up to 14T.

### DETAILED DESCRIPTION

As explained above, there is a need for an improved method of preparing bulk BSCCO-based materials which can be scaled up.

In general terms, the present invention relates to a method of preparing large quantities of bulk BSCCO-based materials, such as BSCCO-2212, which may be in the form of platelets, whiskers and/or needle shape nanoparticles. Moreover, the synthesized material may be subjected to further thermal treatment for crystal growth. The grown micro to millimetre sized-crystals/whiskers may exhibit both, high T_{c} superconductive properties and the layered structure that allows exfoliation down to bi-dimensional particles.

In particular, the present invention provides a method of forming bulk BSCCO-based material which is less time consuming with higher chemical stability since no pH control is required in each synthesis step. The method of the present invention uses a self-buffering system that minimizes the segregation of undesired phases. While all previous methods of obtaining 2D BSCCO particles are based on the mechanical cleavage of bulk single crystals, the present method may involve mechanical exfoliation of grown material to 2D crystals obtained from single- or a poly-crystalline structure.

BSCCO-2212 is a material used for high magnetic field applications. It is one of the few high temperature ceramic (HTC), which is used in commercial fabrication of superconducting wires that have been used in the construction of accelerator magnets. Other applications may include use in MRI, NMR, induction heaters, transformers, fault current limiters, power storage, motors, generators, fusion reactors and magnetic levitation devices.

According to a first aspect, the present invention provides a method of preparing bulk BSCCO-based materials, the method comprising:
mixing a first solution with a second solution at a pre-determined temperature to form a gel, wherein the first solution comprises salts of at least bismuth, strontium, calcium and copper and the second solution comprises a precipitating agent;
drying the gel to form a xerogel;
grinding the xerogel to form a homogeneous metalorganic precursor; and
calcining the homogeneous metalorganic precursor to form bulk BSCCO-based material.

The first solution may comprise any suitable salt of at least bismuth, strontium, calcium and copper. According to a particular aspect, the first solution may comprise an aqueous solution of a salt of at least bismuth, strontium, calcium and copper. For example, the salt may be an O-containing salt of at least bismuth, strontium, calcium and copper. According to a particular aspect, the first solution may comprise acetates, methanoates, propanoates, or a combination thereof of at least bismuth, strontium, calcium and copper. In particular, the first solution may comprise acetates of at least bismuth, strontium, calcium and copper.

The first solution may be prepared by any suitable method. For example, the salts of at least bismuth, strontium, calcium and copper may be dissolved in a suitable aqueous solvent. The aqueous solvent may be water. The dissolving may comprise stirring the mixture.

The first solution may further comprise a buffering agent. The buffering agent may be any suitable buffering agent. According to a particular aspect, the buffering agent may be a conjugate acid. For example, the buffering agent may be, but not limited to: acetic acid, formic acid, propanoic acid, hydracrylic acid, or a combination thereof. In particular, the buffering agent may be aqueous acetic acid.

The buffering agent may have any suitable concentration. For example, the concentration of the buffering agent may be 20-50% volume/volume (v/v). In particular, the concentration of the buffering agent may be 25-45% v/v, 30-40% (v/v), 35-38% v/v. Even more in particular, the concentration of the buffering agent may be 20-25% v/v.

The second solution may be prepared by any suitable method. For example, the second solution may be a means for precipitation. Accordingly, the second solution may be prepared by mixing a precipitating agent in a suitable solvent. The solvent may be an organic solvent.

The precipitating agent may be any suitable precipitating agent. For example, the precipitating agent may be, but not limited to: oxalic acid, malonic acid, maleic acid, or a combination thereof. In particular, the precipitating agent may be oxalic acid.

The organic solvent may be any suitable organic solvent. For example, the organic solvent may be, but not limited to: isopropanol, n-propanol, n-butanol, t-butanol, or a combination thereof. In particular, the organic solvent may be isopropanol solution. According to a particular aspect, the second solution may be prepared by mixing oxalic acid in isopropanol solution in water.

The temperature of the second solution may be lowered. The temperature of the second solution may be lowered by any suitable method. For example, the temperature of the second solution may be lowered by placing the second solution in a water bath of suitable temperature. In particular, the temperature of the second solution may be lowered by placing the second solution in a thermostatic bath. The thermostatic bath may be maintained at a suitable temperature such as, −2-5° C. In particular, the thermostatic bath may be at a temperature of −1-4° C., 0-3° C., 1-2° C. Even more in particular, the thermostatic bath may be at a temperature of about 0° C.

According to a particular aspect, the mixing may comprise adding the first solution to the second solution. In particular, the mixing may comprise adding the first solution to the second solution, wherein the second solution is in a thermostatic bath at a pre-determined temperature. The pre-determined temperature may be any suitable temperature. For example, the pre-determined temperature may be −2-5° C. In particular, the pre-determined temperature may be −1-4° C., 0-3° C., 1-2° C. Even more in particular, the pre-determined temperature may be about 0° C.

The mixing may further comprise stirring the mixture while the first solution is added to the second solution. The mixing at the pre-determined temperature may result in supersaturation of the first solution, thereby causing crystallization and formation of a gel.

The method may further comprise washing the gel. The washing may be by any suitable method. For example, the washing may comprise repeated washing of the gel to neutralise the filtrate.

Following the washing, the method may comprise drying the gel. In particular, the method may comprise drying the gel to form a xerogel. The drying may be under suitable conditions. In particular, the drying may comprise drying the gel at a suitable temperature. For example, the drying may be at a temperature of 35-150° C. In particular, the drying may be at a temperature of 40-140° C., 50-130° C., 60-120° C., 70-110° C., 80-100° C., 90-95° C. Even more in particular, the drying may be at a temperature of about 40° C.

The drying may be carried out for any suitable period of time. In particular, the drying may be carried out for a suitable period of time until the mass of the xerogel is constant.

The method may further comprise grinding the xerogel to obtain a homogeneous metalorganic precursor. The grinding may be by any suitable method. The homogeneous metalorganic precursor obtained may be in the form of a powder. In particular, the homogeneous metalorganic precursor may be in the form of fine powder.

The method may comprise calcining the homogeneous metalorganic precursor to completely melt the homogeneous metalorganic precursor and form bulk BSCCO-based material. The calcining may be under suitable conditions. For example, the calcining may comprise calcining the homogeneous metalorganic precursor at a suitable temperature. The calcining may be at a temperature of 600-1000° C. In particular, the calcining may be at a temperature of 625-975° C., 650-950° C., 675-925° C., 700-900° C., 725-875° C., 750-850° C., 775-825° C., 800-810° C. Even more in particular, the calcining may be at a temperature of about 700° C.

The calcining may be carried out for a suitable period of time. According to a particular aspect, the calcining may be carried out for 5-10 hours/g of the homogeneous metalorganic precursor.

The method may further comprise grinding the bulk BSCCO-based material. The ground bulk BSCCO-based material may then be pelletized to form pelletized bulk BSCCO-based material. The pelletizing may be under suitable conditions. In particular, the pelletizing may be under a suitable pressure.

The method may further comprise heating the pelletized bulk BSCCO-based material. The heating may comprise sintering the pelletized bulk BSCCO-based material. The heating may be under suitable conditions. According to a particular aspect, the heating may be under oxidising atmosphere. In particular, the heating may comprise heating at a suitable temperature. For example, the heating may be at a temperature of 700-950° C. In particular, the heating may be at a temperature of 725-925° C., 750-900° C., 775-875° C., 800-850° C., 810-825° C. Even more in particular, the heating may be at a temperature of about 800° C.

The heating may be carried out for a suitable period of time. For example, the heating time may be dependent on the size of the material. According to a particular aspect, the heating may be carried out for 12-24 hours.

According to a particular aspect, the bulk BSCCO-based material may comprise BSCCO-2212. In particular, the bulk BSCCO-based material may comprise Bi_{1.8}Sr_{1.8}Ca_{1.2}Cu_{2.2}O_{8.22}.

The bulk BSCCO-based material may be any suitable form. For example, the bulk BSCCO-based material may be in the form of BSCCO-2212 platelets, BSCCO-2212 whiskers, or a combination thereof. According to a particular aspect, the bulk BSCCO-based material may be polycrystalline BSCCO-2212 formed by platelets. For the purposes of the present invention, platelets are defined as a laminate structure comprising several stacked layers which may be split apart.

According to a particular aspect, the method may further comprise growing BSCCO crystals from the bulk BSCCO-based material. The BSCCO crystals may be grown by any suitable method. The BSCCO crystals may be grown in air. For example, the BSCCO crystals may be grown on a suitable substrate by thermal treatment. The BSCCO crystals may be grown at a temperature of 1000-1400° C. In particular, the temperature may be 1050-1350° C., 1100-1300° C., 1150-1250° C., 1200-1225° C. Even more in particular, the temperature may be about 1200° C.

The substrate on which the BSCCO crystals are grown may be any suitable substrate. For example, the substrate may be a metallic substrate. In particular, the metallic substrate may comprise any metal in which the cations of BSCCO are insoluble and which remains stable in air at high temperatures. According to a particular aspect, the substrate may comprise platinum.

The BSCCO crystals may comprise whiskers. According to a particular aspect, the BSCCO crystals may comprise whiskers of at least one dimension ≤1 mm. The whiskers may have an average width of 30-70 μm. In particular, the whiskers may have an average width of 35-65 μm, 40-60 μm, 45-55 μm, 50-52 μm. Even more in particular, the whiskers may have an average width of 50 μm.

The method may further comprise exfoliating the BSCCO crystals to form exfoliated 2D BSCCO flakes. The exfoliation may be by any suitable method. For example, the exfoliation may be mechanical exfoliation, liquid phase exfoliation, or a combination thereof. In particular, the exfoliation may be by scotch tape micromechanical cleavage method.

The 2D BSCCO flakes may have any suitable shape. For example, the 2D BSCCO flakes may be, but not restricted to, needle shaped, spherical, nanorods, nanowires, nanotubes, nanocubes, or a combination thereof. In particular, the 2D BSCCO flakes may be needle shaped and/or lamellar shaped.

The 2D BSCCO flakes may have a suitable size. For example, at least one dimension of the 2D BSCCO flake may have a dimension of 20 μm. In particular, at least one dimension of the 2D BSCCO flake may have a dimension of 10 μm, 1000 nm, 500 nm.

The exfoliated 2D BSCCO flakes may be dispersed in a suitable solvent to form an ink that may be deposited on a substrate surface to form a thin film. The depositing may be by any suitable method. For example, the depositing may be by, but not limited to: drop-casting, spin coating, slit coating, spray coating, slot die coating, inkjet printing, doctor blading, or a combination thereof. The film thickness may be controlled by, for example, altering the concentration of the ink and/or by changing the size of the exfoliated 2D BSCCO flakes.

The method of the present invention allows the production of large quantities of the BSCCO-2212 in form of bulk BSCCO-based material. The synthetized material may be submitted to thermal treatment for crystal growth. The grown micro-crystals exhibit both, high T_{c} superconductive properties and the layered structure that allows exfoliation down to bi-dimensional particles. Furthermore, the exfoliation of grown material to 2D flakes may be performed for the single-crystalline structure of the grown material, or even in the case of a growth poly-crystalline structure.

According to a second aspect, the present invention provides a nano-device comprising exfoliated 2D BSCCO crystals formed from the method according to the first aspect. The nano-device may be any suitable device. The exfoliated 2D BSCCO flakes may be deposited on a substrate.

### Example

### Synthesis Method

4.35 g bismuth acetate, 2.31 g strontium acetate, 0.89 g calcium acetate and 2.05 g copper acetate were dissolved in aqueous acetic acid (20% v/v) at room temperature under vigorous stirring to form a first solution. The first solution was kept stable after heating at 40° C. under vigorous stirring.

1M oxalic acid was prepared as a precipitating agent, which was dissolved in aqueous isopropanol (50% v/v) to form a second solution. After complete dissolution, the second solution was placed in a thermostatic bath at 0° C. and kept at rest until the achievement of thermal equilibrium.

The first solution was then poured into the second solution with constant stirring. After cooling, the system was supersaturated and only showed evidence of crystallization at the time of mixing with the second solution. After mixing the two solutions in a thermostatic bath at 0° C., a gel was formed, in a clear blue coloration, due to the presence of copper ions. The gel was then washed repeatedly in a Buchner funnel attached to a vacuum pump until complete neutralization of the filtrate. After washing, the gel was dried at 40° C. for 24 hours to obtain a xerogel.

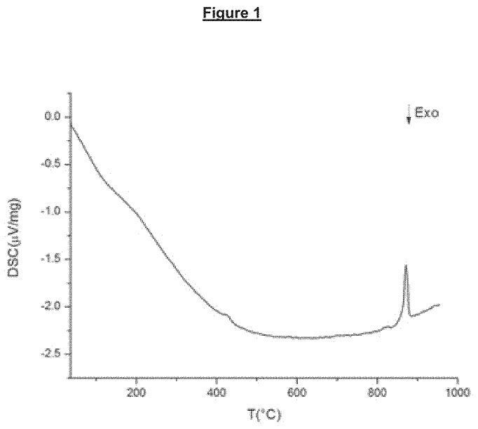

The obtained xerogel was ground in an agate mortar to obtain a fine powder, which was fired at a temperature of 700° C. with a baseline of 12 hours. A Differential Scanning Calorimetry (DSC) analysis of the calcined product is shown in FIG. 1, where the exothermic peak at 880° C. clearly indicates a physical transformation, i.e. a complete melting of the material. The calcined material was ground in agate mortar for 10 minutes and the resulting powder was pressed in a unidirectional hydraulic press with a pressure of 31.2 MPa. Subsequently, the resulting pellets were sintered in a muffle at 800° C. under oxidizing atmosphere with 15 hours baseline.

### Characterization of the Synthesized Material

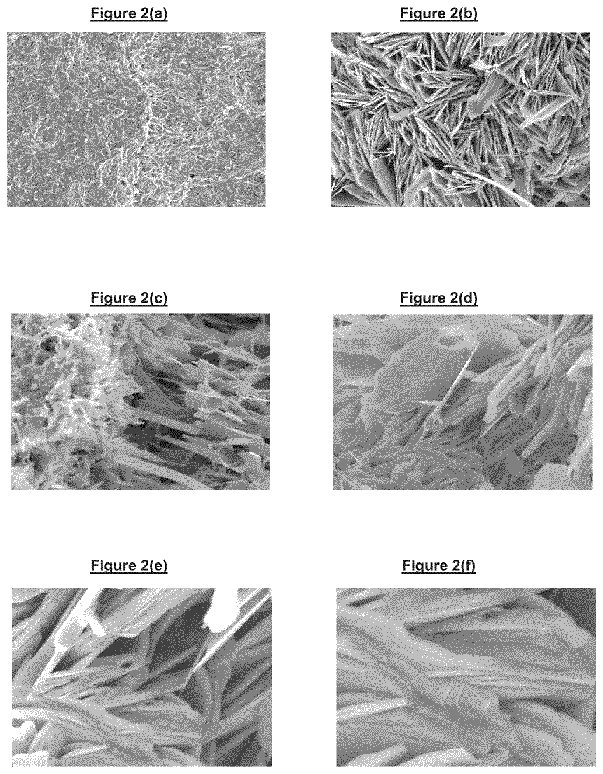

The morphological characteristics of the sintered material are presented in FIG. 2, which shows the SEM images of needle and mainly lamellar shaped particles with lateral sizes of the order of 10 μm. A dispersion of this material was used as suspension of 2D particles.

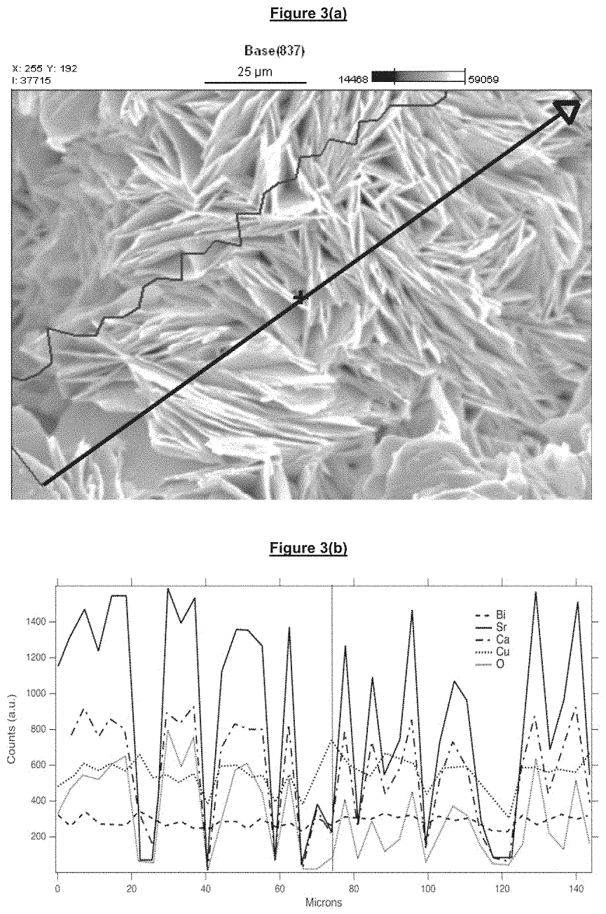

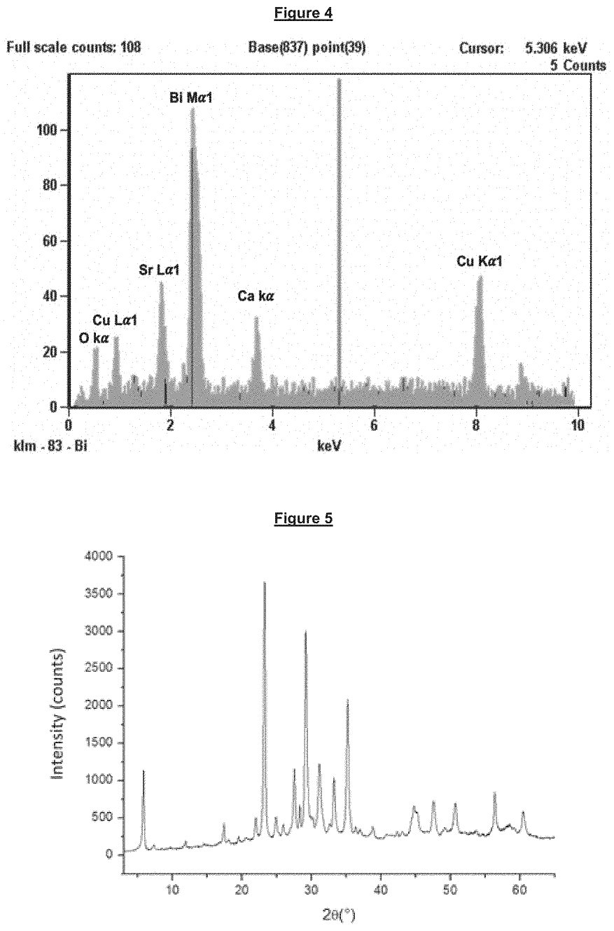

An Energy Dispersion Spectroscopy (EDS) analysis, performed in a line across the lamellae, confirmed a homogeneous compositional distribution of the elements, as seen in FIG. 3. As seen in FIG. 4, no significant quantities of impurities were present in the emission spectrum of that region. The semi-quantitative analysis is presented in Table 1, with values that indicate an average composition near the 2212 phase.

TABLE 1
Semi-quantitative composition of sintered material by EDS

| Element | | Weight | Atomic |
|---|---|---|---|
| radiation | Counts | (%) | mass (%) |
| O—K | 103 | 6.87 | 35.34 |
| Ca—K | 314 | 3.76 | 7.72 |
| Cu—K | 606 | 11.66 | 15.10 |
| Sr—K | 96 | 20.63 | 19.37 |
| Bi—K | 522 | 57.08 | 22.48 |
| Total | | 100 | 100 |

FIG. 5 shows the X-ray diffractogram from the sintered sample using conventional diffractometer with CuK_{α} radiation. The experimental conditions in step scan mode were 3°≤2≤120°, 0.005°/step and 2 seconds/step as integration time. The collected diffraction data allowed the phase identification by means of the International Centre for Diffraction Data (ICDD) database. The main phase was BSCCO-2212, as presented in Table 2.

TABLE 2
Phases identification from X-ray diffraction of sintered BSCCO sample

| | | Intensity | | |
|---|---|---|---|---|
| 2θ (°) | d (Å) | (counts) | Phase (hkl) | Chemical composition |
| 5.8352 | 15.1335 | 72827 | Bi Sr Ca Cu Oxide | Bi_{1.8}Ca_{1.2}Sr_{1.8}Cu_{2.2}O_{8.22} |
| | | | (0, 0, 2) | |
| 11.9264 | 7.4153 | 557 | Bi Sr Ca Cu Oxide | Bi_{1.8}Ca_{1.2}Sr_{1.8}Cu_{2.2}O_{8.22} |
| | | | (0, 0, 4) | |
| 17.3737 | 5.1002 | 18113 | Bi Sr Ca Cu Oxide | Bi_{1.8}Ca_{1.2}Sr_{1.8}Cu_{2.2}O_{8.22} |
| | | | (0, 0, 6) | |
| 23.27651 | 3.81842 | 234948 | Bi Sr Ca Cu Oxide | Bi_{1.8}Ca_{1.2}Sr_{1.8}Cu_{2.2}O_{8.22} |
| | | | (0, 0, 8) | |
| 24.91716 | 3.5712 | 16913 | Bi Sr Ca Cu Oxide | Bi_{1.8}Ca_{1.2}Sr_{1.8}Cu_{2.2}O_{8.22} |
| | | | (1, 1, 3) | |
| 27.5349 | 3.23691 | 53523 | Bi Sr Ca Cu Oxide | Bi_{1.8}Ca_{1.2}Sr_{1.8}Cu_{2.2}O_{8.22} |
| | | | (1, 1, 5) | |
| 28.29614 | 3.15151 | 21415 | Ca Sr Cu Bi Oxide | (Ca Sr) (Cu_{1.5}Bi_{0.5}) O₄ |
| | | | (0, 0, 1) | |
| 29.1853 | 3.05743 | 187243 | Bi Sr Ca Cu Oxide | Bi_{1.8}Ca_{1.2}Sr_{1.8}Cu_{2.2}O_{8.22} |
| | | | (0, 0, 10) | |
| 31.07711 | 2.87551 | 51323 | Bi Sr Ca Cu Oxide | Bi_{1.8}Ca_{1.2}Sr_{1.8}Cu_{2.2}O_{8.22} |
| | | | (1, 1, 7) | |
| 32.538 | 2.7507 | 447 | Ca Sr Cu Bi Oxide | (Ca Sr) (Cu_{1.5}Bi_{0.5}) O₄ |
| | | | (2, 0, 0) | |
| 33.17411 | 2.69839 | 46622 | Bi Sr Ca Cu Oxide | Bi_{1.8}Ca_{1.2}Sr_{1.8}Cu_{2.2}O_{8.22} |
| | | | (0, 2, 2) | |
| 35.2146 | 2.54664 | 126236 | Bi Sr Ca Cu Oxide | Bi_{1.8}Ca_{1.2}Sr_{1.8}Cu_{2.2}O_{8.22} |
| | | | (0, 2, 4) | |
| 37.033 | 2.4262 | 356 | Bi Sr Ca Cu Oxide | Bi_{1.8}Ca_{1.2}Sr_{1.8}Cu_{2.2}O_{8.22}, |
| | | | (0, 2, 6), | (Ca Sr) (Cu_{1.5}Bi_{0.5}) O₄ |
| | | | Ca Sr Cu Bi Oxide | |
| | | | (2, 1, 0) | |
| 44.822 | 2.020410 | 22915 | Bi Sr Ca Cu Oxide | Bi_{1.8}Ca_{1.2}Sr_{1.8}Cu_{2.2}O_{8.22} |
| | | | (0, 2, 10) | |
| 47.51615 | 1.91206 | 27317 | Bi Sr Ca Cu Oxide | Bi_{1.8}Ca_{1.2}Sr_{1.8}Cu_{2.2}O_{8.22} |
| | | | (2, 2, 0) | |
| 50.66819 | 1.80026 | 27317 | Bi Sr Ca Cu Oxide | Bi_{1.8}Ca_{1.2}Sr_{1.8}Cu_{2.2}O_{8.22} |
| | | | (1, 1, 15) | |
| 56.3519 | 1.63142 | 46922 | Bi Sr Ca Cu Oxide | Bi_{1.8}Ca_{1.2}Sr_{1.8}Cu_{2.2}O_{8.22} |
| | | | (1, 1, 17) | |
| 58.496 | 1.576715 | 477 | Bi Sr Ca Cu Oxide | Bi_{1.8}Ca_{1.2}Sr_{1.8}Cu_{2.2}O_{8.22}, |
| | | | (0, 2, 16), | (Ca Sr) (Cu_{1.5}Bi_{0.5}) O₄ |
| | | | Ca Sr Cu Bi Oxide | |
| | | | (3, 0, 1) | |
| 60.41816 | 1.53094 | 18414 | Bi Sr Ca Cu Oxide | Bi_{1.8}Ca_{1.2}Sr_{1.8}Cu_{2.2}O_{8.22} |
| | | | (2, 2, 12) | |

Bi Sr Ca Cu Oxide: Bismuth Calcium Strontium Copper Oxide after ICDD nomenclature
Ca Sr Cu Bi Oxide: Calcium Strontium Copper Bismuth Oxide after ICDD nomenclature

The phase identification analysis indicates that the most significant amount corresponds to the superconducting phase of nominal stoichiometry Bi_{1.8}Ca_{1.2}Sr_{1.8}Cu_{2.2}O_{8.22}. The other is a not superconducting phase with composition Bi_{0.5}SrCaCu_{1.5}O₄. This identification was reliable due to the values of Figures of Merit (FOM) of 1,583 and 1,922 for Bi_{1.8}Ca_{1.2} Sr_{1.8}Cu_{2.2}O_{8.22} and Bi_{0.5}SrCaCu_{1.5}O₄, respectively.

Furthermore, an Atomic Absorption Spectroscopy analysis (AAS) of the bulk sample was performed in order to determine the Cu/Ca ratio. Aliquots of the sample were diluted in concentrated hot nitric acid solution. After dilution, the samples were analyzed in a spectrophotometer Varian AA-1275 with specific hollow cathode lamps for each cation. The weight fractions are showed in Table 3 and the resulting ratio is 1.65, which is related to the main presence of phase 2212.

TABLE 3
Bulk composition of Ca and Cu of the sample
from Atomic Absorption Spectroscopy

| Element | Weight fraction (%) |
|---|---|
| Ca | 8.89 |
| Cu | 14.7 |

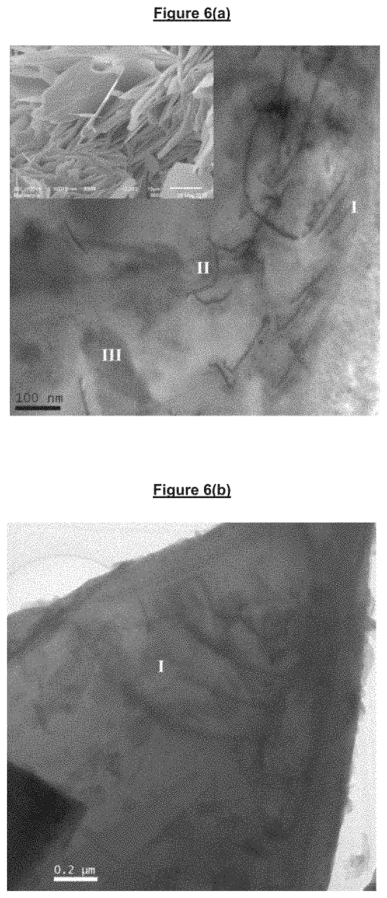

The lamellar particles were also characterized by Transmission Electron Microscopy (TEM). FIG. 6 shows images of crystals with a clear predominance of dislocations. During the analysis, the sample was tilted in order to check the contrast, since this type of defect was sensitive to variations in direction. FIG. 6 (a) shows an area of higher concentration of these defects. In the region indicated by I, dislocations are arranged in a loop, whereas in the region indicated by II there is a possible interruption of dislocations. Furthermore, the region indicated by III shows the presence of segregations or clusters with local compositional variation. The presence of elements with greater or lesser atomic radius or electron density in these places tends to promote tensile and compressive stress fields, respectively. These long-range stress fields propagate through the crystal lattice, favouring the presence of the described defects, such as stacking faults and dislocations. Also, a characteristic contrast of isocline contours is shown in FIG. 6 (b), in the region indicated by I.

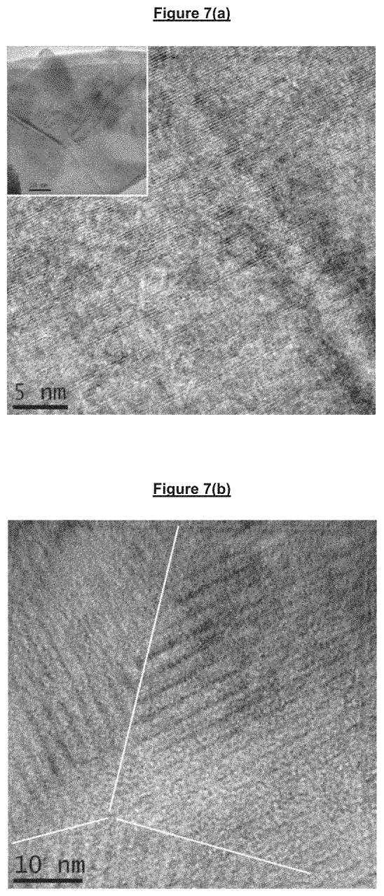

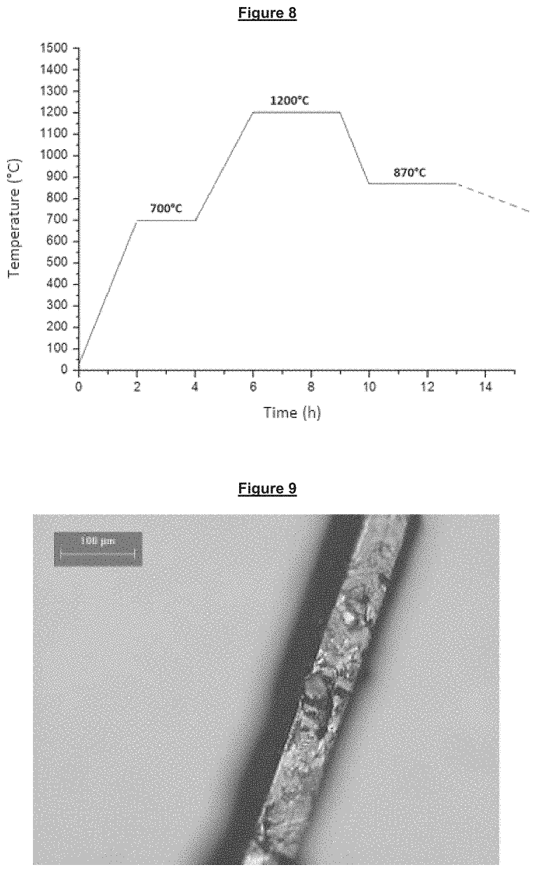

High-resolution images were also taken to characterize local structures. The images in FIG. 7 indicate the presence of a possible sub contour and a region of the interfaces between crystalline domains, indicated by white lines. These defects in the crystalline structure of lamellar particles with thicknesses less than 150 unit cells indicate that they can be easily liquid-phase exfoliated to few layers in a proper solvent.

### Crystal Growth

Crystal growth was carried out using a platinum crucible in a furnace with static ambient air atmosphere. The thermal treatment graph is shown in FIG. 8. A baseline of 1200° C. was used, so that the designed growth model was based on melting mass transport by temperature gradient.

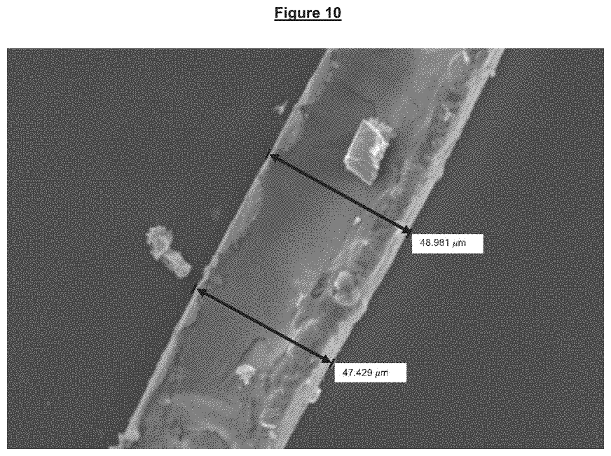

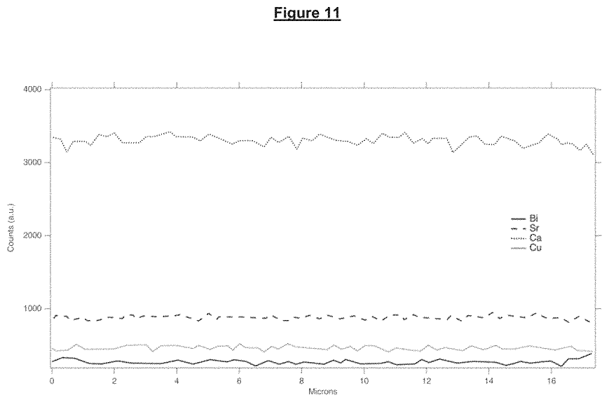

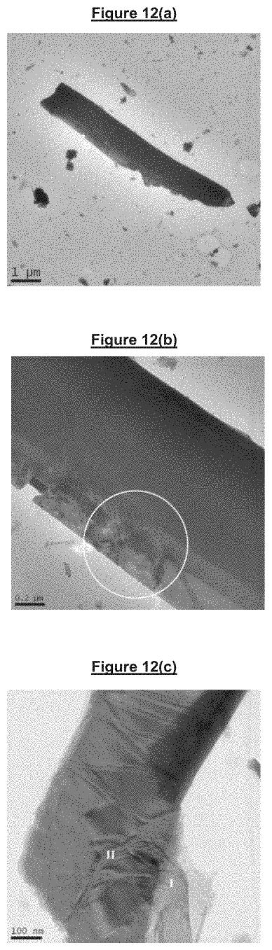

As an example of growth crystals, whiskers of size up to approximately 1 mm were seen by optical microscopy (OM), in FIG. 9, and scanning electron microscopy (SEM), in FIG. 10. The SEM analysis shows that the average width of the whiskers was approximately 50 μm and their composition was uniform, as seen in FIG. 11.

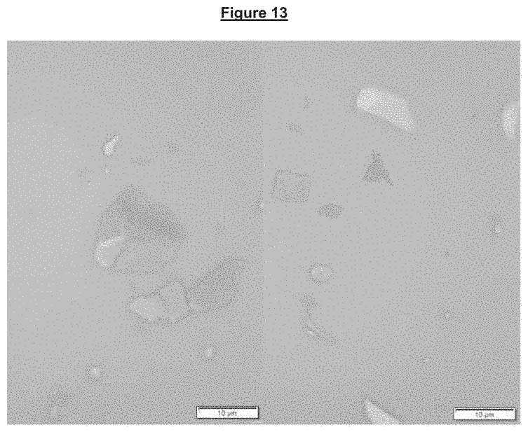

Images of several whiskers characterized by TEM are presented in FIG. 12, where disordered regions appear clearly. The region marked by a circle in one whisker in FIG. 12(b) shows a characteristic modulation that indicates possible stacking faults. The same type of defect was observed in another whisker, shown in the region denoted by I in FIG. 12(c). In the region denoted by II in FIG. 12(c), there is possibly a high degree of disorder. This region may contain different types of defects related to characteristics associated with both stacking faults and surface steps, as well as the isocline contours, which are generated by thickness variations along the sample. Therefore, the presence of different types of structural disorder was confirmed by local analysis.

### Mechanical Exfoliation of Whiskers

As a strong anisotropic material, BSCCO-2212 has a cleavage plane, the BiO plane, which allows easy application of the scotch tape micromechanical cleavage method. The process of peeling of various whiskers, repeated a few times, resulted in a large number and variety of high-quality flakes, that were transferred to a silicon substrate covered with a 300 nm silicon oxide layer. Depending on their thicknesses, these flakes showed different coloration, since the optical properties changed pronouncedly with thickness. As seen in FIG. 13, crystalline defects also influenced the coloration of flakes with different sizes up to approximately 20 μm.

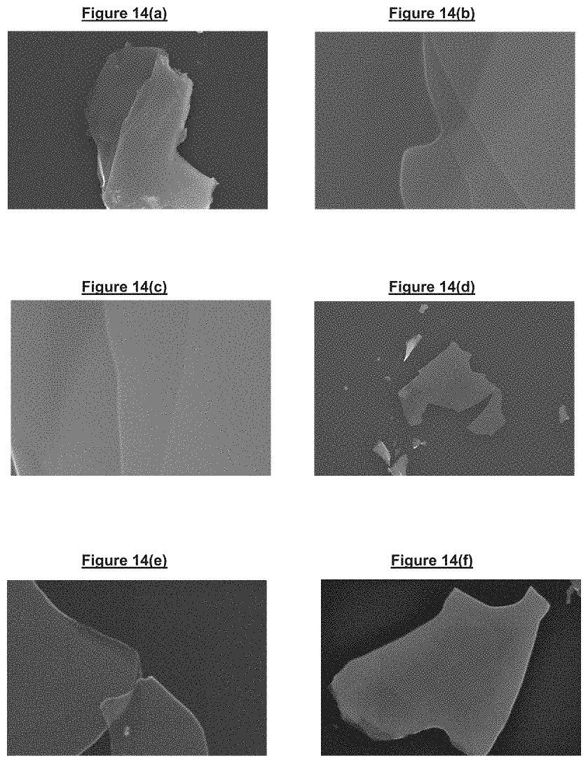

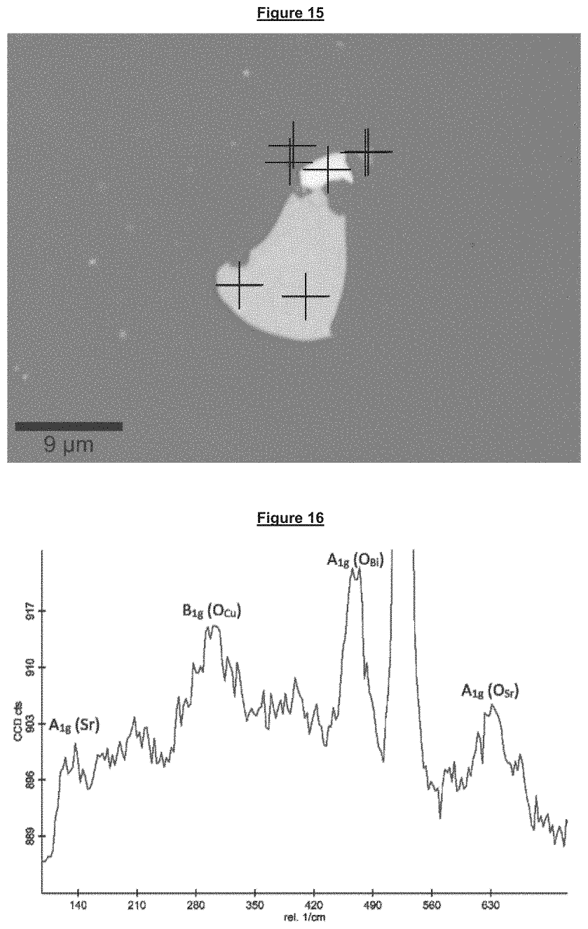

As seen in FIG. 14, SEM analysis of some flakes showed the stacking of few layers with an almost perfect crystallinity.

EDS semi quantitative analysis of those flakes shows a near composition to the whisker's composition, i.e. the phase 2212, as presented in Table 4.

TABLE 4
Semi quantitative analysis by EDS of BSCCO flakes

| Element | | Weight | Atomic |
|---|---|---|---|
| radiation | Counts | (%) | mass (%) |
| O—K | 3651 | 8.34 | 14.79 |
| Ca—K | 5187 | 1.36 | 0.96 |
| Cu—K | 8039 | 3.23 | 1.44 |
| Sr—K | 1384 | 4.58 | 1.48 |
| Bi—K | 8502 | 16.74 | 2.27 |

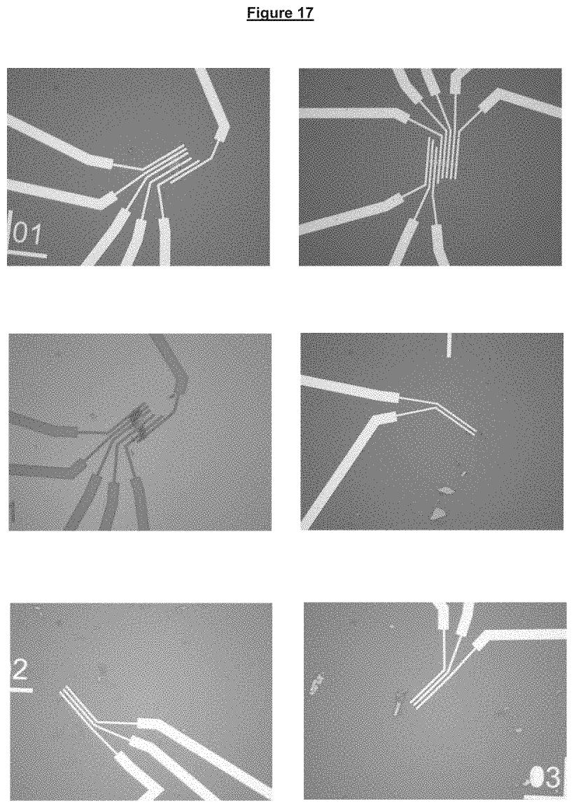

The Raman spectra, collected using a 532 nm laser source corresponded to those reported in the literature. In FIG. 15, a typical flake with marked regions where the spectra are collected is shown. The peaks of vibrational modes A_{1g} (Sr), B_{1g} (O_{Cu}), A_{1g} (O_{Bi}) and A_{1g} (O_{Sr}) are registered with low intensities, as seen in FIG. 16 and as reported for single crystals with thicknesses up to 177 nm. This means a maximum of 6 cell units of BSCCO-2212.

### Nano-Device Fabrication

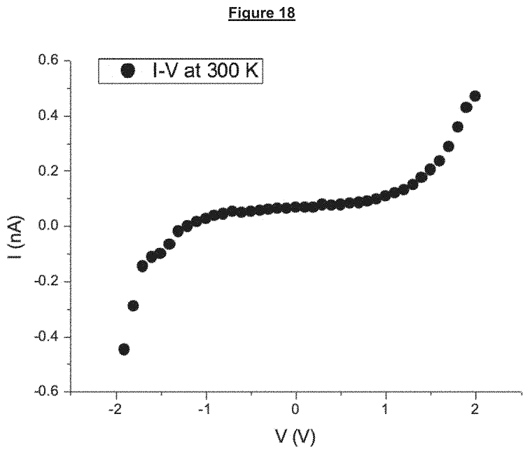

Nano devices were fabricated by mechanically exfoliating BSCCO-2212 crystal and depositing them on an arbitrary substrate. The mechanically-isolated 2D flakes had lateral dimensions between 5 and 10 μm and thicknesses of approximately 40 nm, as measured by AFM. The flakes were patterned by e-beam lithography and contacted by evaporating Ag and Cu contacts. FIG. 17 shows examples of these devices.

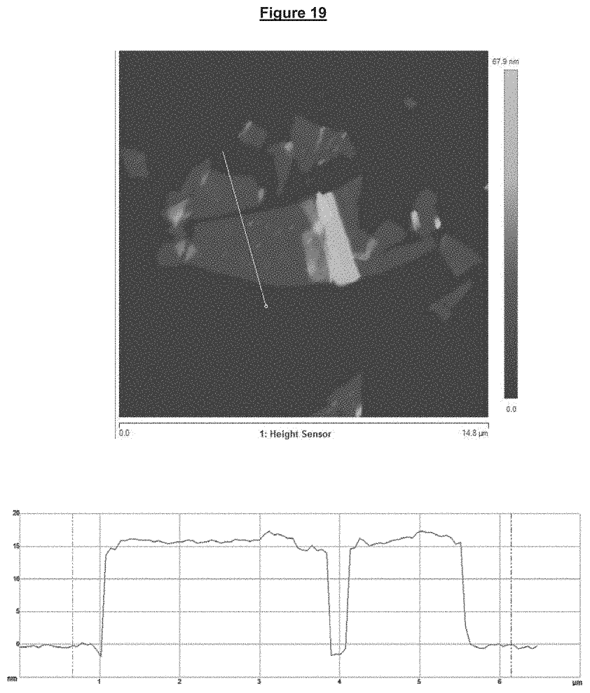

FIG. 18 shows a two-point electrical characterization at room temperature of a fabricated nano-device, which exhibits an insulating behaviour typical of ceramic high temperature superconductors.

### Atomic Force Microscopy Characterization

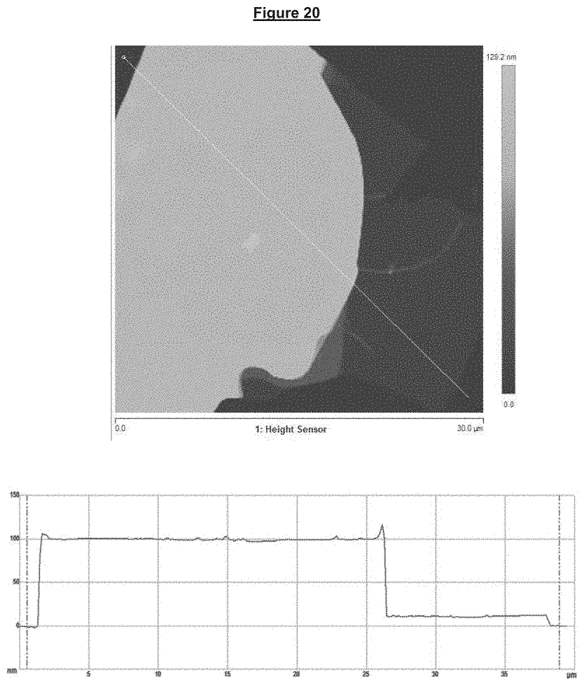

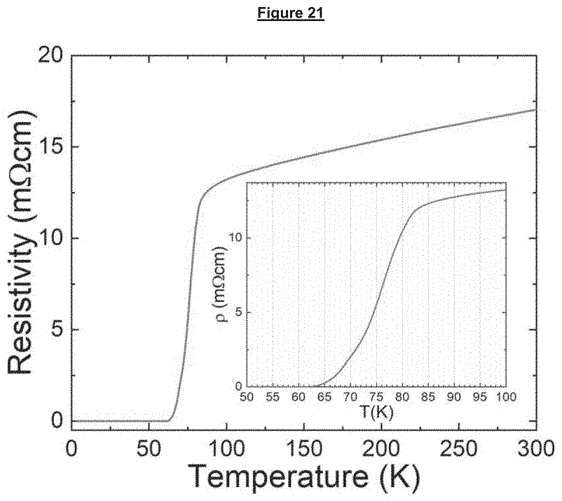

The thickness of typical thin flakes with lateral dimensions of approximately 10 μm was measured by AFM and shown in FIG. 19, with a thickness corresponding to 5 unit cells. As seen in FIG. 20, other nano-platelets obtained by mechanical exfoliation exhibit thicknesses of the order of 30 unit cells.

### T_{c} Evaluation

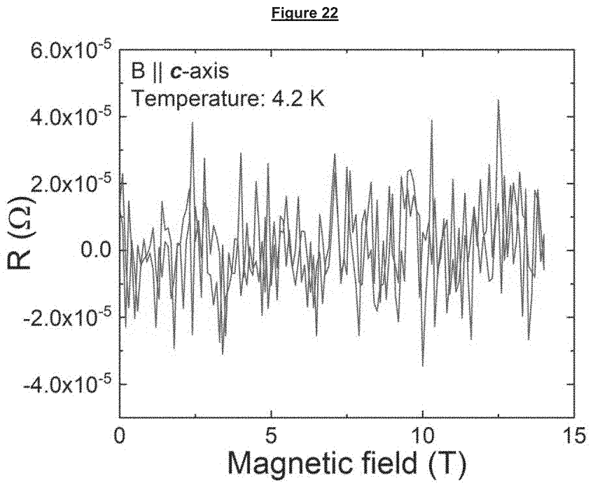

A whisker of BSCCO-2212 was manually exfoliated and a micro platelet was contacted with four silver contacts, several millimetres apart. To improve the contact resistance, the sample was annealed for 30 minutes at 600° C. in air atmosphere. As seen in FIG. 21, the extracted resistivity as a function of temperature shows a clear drop in resistivity that starts at 82.4K and reaches 0 at 61K. As seen in FIG. 22, the magnetoresistance at 4.2K stayed zero under an applied magnetic field of up to 14T, confirming that the superconductivity is a property of the bulk crystal.

Whilst the foregoing description has described exemplary embodiments, it will be understood by those skilled in the technology concerned that many variations may be made without departing from the present invention. Further, the exemplary embodiments are only examples, and are not intended to limit the scope, applicability, operation or configuration of the invention in any way.

1. A method of preparing bulk BSCCO-based material, the method comprising:
mixing a first solution with a second solution at a pre-determined temperature to form a gel, wherein the first solution comprises salts of at least bismuth, strontium, calcium and copper and the second solution comprises a precipitating agent;
drying the gel to form a xerogel;
grinding the xerogel to form a homogeneous metalorganic precursor; and
calcining the homogeneous metalorganic precursor to form bulk BSCCO-based material.

2. The method according to claim 1, wherein the first solution comprises 0-containing salts of at least bismuth, strontium, calcium and copper.

3. The method according to claim 2, wherein the first solution comprises acetates, methanoates, propanoates, or a combination thereof, of at least bismuth, strontium, calcium and copper.

4. The method according to claim 1, wherein the first solution comprises an aqueous solution comprising the salts of at least bismuth, strontium, calcium and copper.

5. The method according to claim 1, wherein the second solution comprises the precipitating agent in an organic solvent.

6. The method according to claim 5, wherein the organic solvent is: isopropanol solution, n-propanol, n-butanol, t-butanol, or a combination thereof.

7. The method according to claim 1, wherein the precipitating agent is: oxalic acid, malonic acid, maleic acid, or a combination thereof.

8. The method according to claim 1, wherein the pre-determined temperature is −2-5° C.

9. The method according to claim 1, wherein the drying comprises drying the gel at a temperature of 35-150° C.

10. The method according to claim 1, wherein the calcining comprises calcining the homogeneous metalorganic precursor at a temperature of 600-1000□C.

11. The method according to claim 1, wherein the calcining comprises calcining the homogeneous metalorganic precursor for 5-10 hours/g of homogeneous metalorganic precursor.

12. The method according to claim 1, further comprising pelletizing the bulk BSCCO-based material to form pelletized bulk BSCCO-based material.

13. The method according to claim 12, further comprising heating the pelletized bulk BSCCO-based material.

14. The method according to claim 13, wherein the heating comprises heating at a temperature of 700-950° C.

15. The method according to claim 13, wherein the heating comprises heating for 12-24 hours.

16. The method according to claim 1, wherein the bulk BSCCO-based material comprise BSCCO-2212.

17. The method according to claim 1, wherein the bulk BSCCO-based material comprises Bi_{1.8}Sr_{1.8}Ca_{1.2}Cu_{2.2}O_{8.22}.

18. (canceled)

19. The method according to claim 1, further comprising growing BSCCO crystals from the bulk BSCCO-based material.

20. The method according to claim 19, further comprising exfoliating the BSCCO crystals to form 2D BSCCO flakes.

21. The method according to claim 20, wherein the exfoliating comprises: mechanical exfoliation, liquid phase exfoliation, or a combination thereof.
